(19) United States
(12) Patent Application Publication
(10) Pub. No.: US 2011/0025211 A1
(43) Pub. Date: Feb. 3, 2011

(54) LIGHT EMITTING DIODE LIGHTING DEVICE

(76) Inventor: Byung Am BAE, Busan (KR)

Correspondence Address: BIRCH STEWART KOLASCH & BIRCH, PO BOX 747, FALLS CHURCH, VA, 22040-0747, US

(21) Appl. No.: 12/707,371

(22) Filed: Feb. 17, 2010

(30) Foreign Application Priority Data
Jul. 28, 2009 (KR) 20-2009-0009975
Aug. 17, 2009 (KR) 20-2009-0010764
Sep. 9, 2009 (KR) 20-2009-0011925
Sep. 9, 2009 (KR) 20-2009-0011926

(51) Int. Cl. H01J 13/32; H01J 61/52

(52) U.S. Cl. 315/113; 313/46

(57) ABSTRACT

Provided is a light emitting diode (LED) lighting device, which includes a main frame, at least one metal printed circuit board (PCB) provided at the main frame and having at least one LED bulb installed on a lower surface thereof, a heat sink provided on an upper side of the metal PCB, absorbing heat from the LED bulbs, and dissipating the heat into the air, at least one thermoelectric element provided on a lower side of the heat sink and having a heat absorbing part at a lower portion thereof and a heat radiating part at an upper portion thereof, a temperature sensor measuring temperature of the heat sink or the metal PCB, and at least one cooling fan located on an upper portion or a side portion of the heat sink and inducing heat radiating from the heat sink to an outside to cool the heat sink.

### BACKGROUND OF THE INVENTION

1. Field of the Invention

The present invention relates to a light emitting diode (LED) lighting device, which efficiently dissipates heat from LED bulbs to ensure high output power, high luminance, and high durability.

2. Description of the Related Art

The invention of the lighting device called an incandescent lamp was of benefit to mankind for it released mankind from darkness and thus enabled mankind to work at night. As such, human civilization has more rapidly developed.

From that time on, mankind has made efforts to develop a lighting device that emits brighter light yet consumes low power. As a result, a lot of lighting devices such as fluorescent lamps, compact fluorescent lamps, halogen lamps, etc. have been invented up to the present and are used in our daily life.

With the recent development of light emitting diode (LED) elements that emit light when current flows, interest has been shown in using characteristics of the LED element for such a lighting device. The LED elements emit high-luminance light using low power and have a long lifetime, and thus are regarded as next-generation lighting devices. For this reason, LED elements continue to be actively studied, and some of them have come onto the market as products.

These lighting devices must have a predetermined level of luminance. Thus, in order to produce a single LED lighting device using the LED elements, a plurality of LED bulbs configured of the LED elements must be densely arranged on the single LED lighting device.

Meanwhile, in the case of the LED bulbs being used in isolation as display lamps for household electric appliances such as televisions, telephones, etc., there is no problem with heat generated from each LED bulb. However, in the case of the LED lighting device where numerous LED bulbs are densely arranged, the heat generated from each LED bulb causes the LED lighting device a fatal problem.

Although the LED lighting device has a primarily much longer lifetime than an existing lamp, the LED lighting device suffers from frequent failures and a short lifetime due to a lot of heat generated from the numerous LED bulbs. As such, the LED lighting device has no alternative but to use low-powered LED bulbs and a small number of LED bulbs. Furthermore, since the LED lighting device has much lower illuminance and costs more compared to existing lamps such as the incandescent lamp, the mercury lamp, or the fluorescent lamp, the LED lighting device has difficulty in becoming widely used as the lighting device.

Accordingly, there is an acute need for a method of providing an LED lighting device which has high output power, high luminance, and high durability.

### SUMMARY OF THE INVENTION

Accordingly, the present invention has been made keeping in mind the above problems occurring in the related art, and embodiments of the present invention provide a light emitting diode (LED) lighting device, which more efficiently controls heat generated from LED bulbs to ensure high output power, high luminance, and high durability.

According to embodiments of the present invention, there is provided an LED lighting device, which includes a main frame, at least one metal printed circuit board (PCB) provided at the main frame and having at least one LED bulb installed on a lower surface thereof, a heat sink provided on an upper side of the metal PCB, absorbing heat from the LED bulbs, and dissipating the heat into the air, at least one thermoelectric element provided on a lower side of the heat sink and having a heat absorbing part at a lower portion thereof and a heat radiating part at an upper portion thereof, a temperature sensor measuring temperature of the heat sink or the metal PCB, and at least one cooling fan located on an upper portion or a side portion of the heat sink and inducing heat radiating from the heat sink to an outside to cool the heat sink.

Here, the LED bulbs may be installed on one metal PCB.

Further, the LED lighting device may further include a fixing plate provided on the upper side of the metal PCB.

Also, the metal PCBs may each include one LED bulb, and may be fixed to a fixing plate on the upper side thereof.

Meanwhile, the fixing plate may be formed in a flat plate shape, or in a curved plate shape or a polyhedral plate shape such that the LED bulbs are installed in various directions and cast light at various angles.

Further, the LED lighting device may further include a heat insulator provided on the lower side of the heat sink such that the heat of the heat sink is prevented from being transferred to the metal PCB.

In addition, the LED lighting device may further include a circuit board for controlling operation of the LED lighting device.

According to embodiments of the present invention, the LED lighting device can more efficiently cool the heat generated from the LED bulbs to ensure high output power, high luminance, and high durability.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating a light emitting diode (LED) lighting device according to a first embodiment of the present invention;

FIG. 2 is an exploded view illustrating an LED lighting device according to a first embodiment of the present invention;

FIG. 3 is an exploded view illustrating a modification of an LED lighting device according to a first embodiment of the present invention;

FIG. 4 is an exploded view illustrating an LED lighting device according to a second embodiment of the present invention; and

FIG. 5 is an exploded view illustrating an LED lighting device according to a third embodiment of the present invention.

### DETAILED DESCRIPTION OF THE INVENTION

Reference will now be made in greater detail to exemplary embodiments of the invention with reference to the accompanying drawings. Wherever possible, the same reference numerals will be used throughout the drawings and the description to refer to the same or like parts. The detailed descriptions of objects of known function and construction which would unnecessarily obscure the subject matter of the present invention will be avoided hereinafter. Technical terms, as will be mentioned hereinafter, are terms defined in light of their function in the present invention, which may vary according to the intention or practice of a user or operator, so that the terms should be defined based on the contents of this specification.

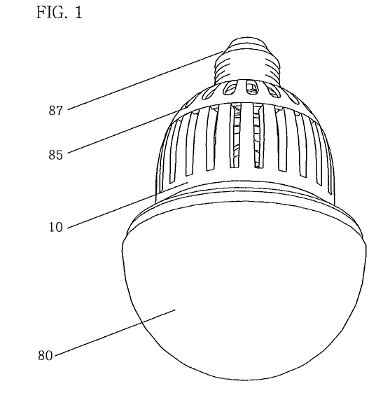

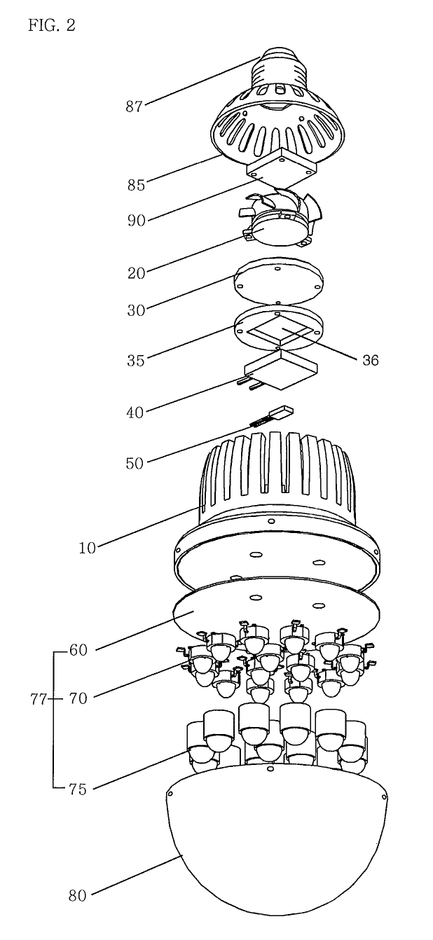

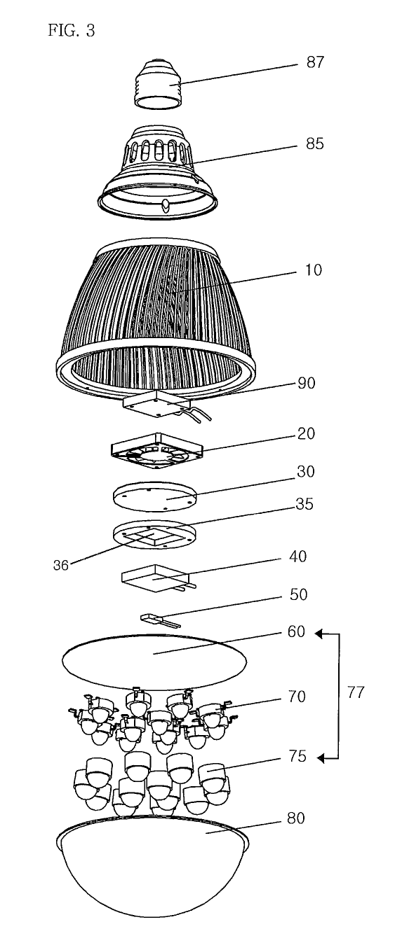

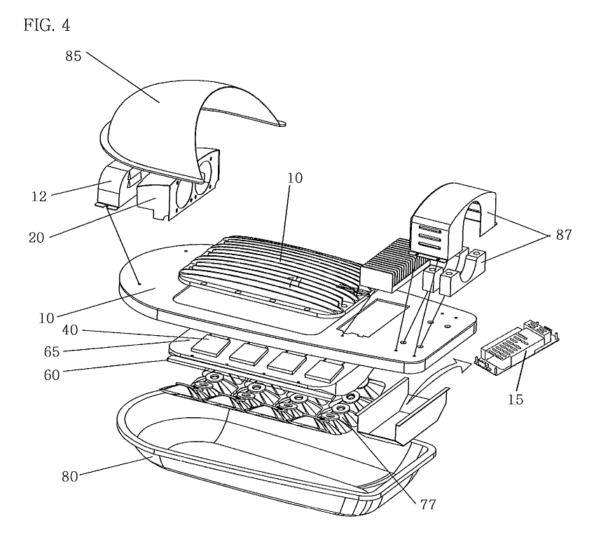

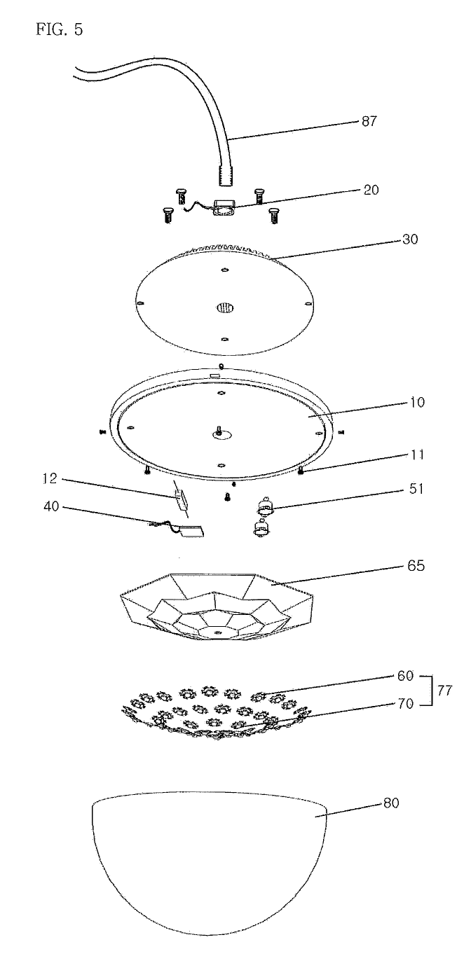

FIG. 1 is a perspective view illustrating a light emitting diode (LED) lighting device according to a first embodiment of the present invention. FIG. 2 is an exploded view illustrating an LED lighting device according to a first embodiment of the present invention. FIG. 3 is an exploded view illustrating a modification of an LED lighting device according to a first embodiment of the present invention. FIG. 4 is an exploded view illustrating an LED lighting device according to a second embodiment of the present invention. FIG. 5 is an exploded view illustrating an LED lighting device according to a third embodiment of the present invention.

An LED lighting device according to embodiments of the present invention generally includes a main frame 10, a plurality of LED bulbs 70, a metal printed circuit board (PCB) 60, a thermoelectric element 40, a temperature sensor 50, a heat sink 30, and a cooling fan 20.

The main frame 10 is a support of the LED lighting device, and thus serves to support each component which will be described below.

Each LED bulb 70 is a known luminous device using an LED element emitting light when current is flowing, and so a detailed description thereof will be omitted.

The metal PCB 60 is a board that has the LED bulbs 70 attached to a lower surface thereof and is printed with a circuit for supplying electric current to the LED bulbs 70. The metal PCB 60 is formed of metal having high thermal conductivity, for instance aluminum material, so as to easily dissipate heat generated from the LED bulbs 70.

Here, as illustrated in FIGS. 2 and 4, the plurality of LED bulbs 70 may be arranged on a single wide metal PCB 60. As illustrated in FIG. 5, a single LED bulb 70 may be disposed on a single small metal PCB 60. Alternatively, a plurality of metal PCBs 60, each of which has at least one LED bulb 70, may be connected and disposed so as to be adjacent to each other, or may be disposed spaced apart from each other by a predetermined distance.

In addition, the plurality of metal PCBs 60 may be disposed in parallel on a single flat plate such that all the LED bulbs 70 can cast light in the same direction. As illustrated in FIG. 5, the plurality of metal PCBs 60 may be disposed on a curved plate or a polyhedral plate such that the LED bulbs can cast light at different angles.

The heat sink 30 is located above the metal PCB 60, and serves to absorb heat from the LED bulbs 70 and then dissipate the heat into the air. The heat sink 60 is formed of metal having high thermal conductivity, and may have a plurality of fins so as to increase a surface area and the resulting heat radiating effect as illustrated in FIG. 4.

Further, the heat sink 30 or the metal PCB 60 is installed so as to be contact with the main frame 10, and the main frame 10 is also formed of metal having high thermal conductivity. Thereby, the heat from the LED bulbs 70 is transferred to the metal PCB 60, the main frame 10, and the heat sink 30, so that the heat can be rapidly dissipated. In other words, the main frame 10 may also be configured to serve as a heat sink.

The cooling fan 20 is mounted on the heat sink 30 or located at a side portion of the heat sink 30, and serves to send air toward the heat sink 30 such that the heat sink 30 can more rapidly dissipate the heat into the air. One or more cooling fans 20 may be provided. The number of cooling fans 20 may be determined depending on size and output power of the LED lighting device.

The thermoelectric element 40 particularly employs a Peltier element. The Peltier element is designed to absorb heat on one side and to dissipate heat on the other side when current is flowing. The operating principle of the Peltier element is known, and so detailed description will be omitted.

The thermoelectric element 40 is installed between the heat sink 30 and the metal PCB 60, and is preferably located so as to be in contact with a lower surface of the heat sink 30. The thermoelectric element 40 serves to rapidly absorb the heat from the LED bulbs 70 with efficiency, and transfer the absorbed heat to the heat sink 30.

The thermoelectric element 40 is disposed in such a manner that an upper portion thereof in contact with the heat sink 30 acts as a heat radiating part and that a lower portion thereof contacted with the metal PCB 60 acts as a heat absorbing part. More specifically, the heat absorbing part of the thermoelectric element 40 absorbs the heat from the plurality of LED bulbs 70 in contact with the metal PCB 60, thereby cooling the LED bulbs 70. In other words, the heat absorbing part of the thermoelectric element 40 absorbs the heat transferred to the metal PCB 60, thereby cooling the LED bulbs 70. In contrast, the heat generated from the heat radiating part of the thermoelectric element 40 is transferred to the heat sink 30, and then is dissipated toward the outside. This heat is more rapidly dissipated outwards by the cooling fan 20.

One or more thermoelectric elements 40 may be mounted. The number of thermoelectric elements 40 may be determined depending on the size and output power of the LED lighting device.

The temperature sensor 50 is disposed between the heat sink 30 and the metal PCB 60, and measures a temperature of the heat sink 30 or the metal PCB 60. Of course, the temperature sensor 50 may measure either the temperature of the heat sink 30 in contact with the upper surface of the heat sink 30 or the temperature of the metal PCB 60 in contact with the lower surface of the metal PCB 60. The LED lighting device according to embodiments of the present invention is controlled by a circuit board 90. A controller of the circuit board 90 receives information on the temperature measured by the temperature sensor 50, and controls driving of the cooling fan 20 on the basis of the temperature information so as to prevent the LED lighting device from rising beyond a predetermined temperature. Here, the controller of the circuit board 90 controls switching on/off of the cooling fan 20. If necessary, the controller may control the revolutions per minute (rpm) of the cooling fan 20.

Meanwhile, the thermoelectric element 40 is configured to be driven whenever powered. If necessary, the controller of the circuit board 90 may be configured to control the driving of the thermoelectric element 40.

In this manner, a device that controls switching on/off of the electric device according to the temperature using the temperature sensor 50 and controller is called a thermostat. In the embodiments of the present invention, the thermostat composed of the temperature sensor and the controller controls the cooling fan 20 and/or the thermoelectric element 40 according to temperature.

Meanwhile, to prevent the heat transferred to the heat sink 30 from being transferred to the metal PCB 60, a heat insulator 35 may be installed on the lower surface of the heat sink 30. The heat insulator 35 is provided on a region where the thermoelectric element 40 is not disposed within the lower surface of the heat sink 30. Thus, as illustrated in FIGS. 2 and 3, the heat insulator 35 is provided with a through-hole 36 into which the thermoelectric element 40 can be fitted. Further, since the temperature sensor 50 may be mounted on the lower surface of the heat sink 30 so as to measure the temperature of the heat sink 30, the heat insulator 35 may be provided with another through-hole into which the temperature sensor 50 can be fitted.

Meanwhile, a fixing plate 65 may be further installed on the metal PCB 60. In detail, the fixing plate 65 may be configured such that an upper surface thereof is in contact with the heat absorbing part of the thermoelectric element 40 and that a lower surface thereof is in contact with the upper surface of the metal PCB 60.

When the metal PCB 60 is thin, a difference in temperature between portions adjacent to and distant from the LED bulbs 70 is somewhat great, and thus heat is not uniformly distributed on the metal PCB 60, so that the heat cannot rapidly radiate. In this case, the fixing plate 65 may be additionally installed on the upper surface of the metal PCB 60 so as to be in contact with the thermoelectric element 40.

The fixing plate 65 may have the shape of a flat plate or a polyhedral plate having faces intersecting at predetermined angles. Of course, the fixing plate 65 may include a curved plate. A plurality of metal PCBs 60, on each of which at least one of the LED bulbs 70 is mounted, are installed on the fixing plate 65. Due to this structure, it is possible for the LED bulbs 70 to emit light in several directions.

The fixing plate 65 is also formed of, but not limited to, metal having high thermal conductivity, preferably aluminum, so as to be able to rapidly transfer the heat from the LED bulbs 70 and metal PCB 60 to the thermoelectric element 40.

Meanwhile, the LED lighting device includes a lower cover 80, which is fixedly installed at a lower portion of the LED lighting device, surrounds the plurality of LED bulbs 70, diffuses light around the LED lighting device, and furnishes an LED lighting device having a smart appearance. Further, the LED lighting device includes an upper cover 85, which is fixedly installed at an upper portion of the LED lighting device.

Either an existing air cooling system configured of the heat sink only or an existing oil cooling system fails to efficiently control the heat generated from the LED lighting device, and thus the temperature of the heat sink rises to 50° C. or more. As a result, the existing cooling systems reduce the lifetime of the LED lighting device, and thus the LED lighting device fails to achieve high output power and high luminance. However, in the case of the cooling system applied to the LED lighting device according to embodiments of the present invention, the heat sink 30 is maintained at a temperature of about 35° C., so that the lifetime of the LED bulbs is increased to a maximum of 80,000 hours, and thus the durability of the LED bulbs are greatly improved. Accordingly, the LED bulbs having high output power are used for LED lighting devices having a small size, so that the LED lighting device having high luminance can be acquired. Further, the LED lighting device having many LED bulbs having high output power can be easily manufactured. Consequently, the LED lighting device can be manufactured so as to have higher output power, luminance, and durability for home or commercial use as well as public use as in a street lamp.

Hereinafter, the exemplary embodiments of the present invention will be described with reference to the accompanying drawings.

### First Embodiment

FIGS. 1 through 3 illuminate an LED lighting device according to a first embodiment of the present invention. This LED lighting device can replace an existing lighting device such as a halogen lamp or an incandescent lamp.

The LED lighting device of this embodiment is equipped with a heat sink 30. A cooling fan 20 is installed on an upper surface of the heat sink 30. A thermoelectric element 40 is installed on a lower surface of the heat sink 30. Further, a temperature sensor 50 is installed on the lower surface of the heat sink 30.

Further, the LED lighting device of this embodiment is equipped with a main frame 10 to form the appearance. The aforementioned components are housed in the main frame 10.

Meanwhile, a lamp module 77 is mounted on a lower portion of the main frame 10. The lamp module 70 includes a metal PCB 60 and a plurality of LED bulbs 70 installed on a lower surface of the metal PCB 60. Each LED bulb 70 is covered with a diffusion lens 75. Further, the main frame 10 is coupled with a lower cover 80, which can cover all the LED bulbs 70.

Heat transferred from the metal PCB 60 of the lamp module 77 mounted on the lower portion of the main frame 10 may be transferred to the heat sink 30 as well as the main frame 10 through the thermoelectric element 40, so that the LED bulbs 70 can be more rapidly cooled, and cooling efficiency is doubled by the cooling fan 20.

Meanwhile, a heat insulator 35 is installed on the lower surface of the heat sink 30, which prevents the heat transferred to the heat sink 30 from being transferred back to the metal PCB 60. The heat insulator 35 is provided on a region where the thermoelectric element 40 is not disposed within the lower surface of the heat sink 30. To this end, the heat insulator 35 is provided with a through-hole 36 in the remaining region where the thermoelectric element 40 is disposed. Of course, although not shown, the heat insulator 35 is provided with another through-hole in a region where the temperature sensor 50 is disposed.

A circuit board 90 is installed in the main frame 10, which controls the LED lighting device. The circuit board 90 serves to receive information about the temperature of the temperature sensor 50 to control the operation of the cooling fan 20 and/or the thermoelectric element 40.

An upper cover 85 is installed on the main frame 10, which covers an upper portion of the LED lighting device. A fixture 87 is installed at an upper end of the upper cover 85, which fixedly connects the LED lighting device to an electrical connector such as a socket.

As shown, the fixture 87 is a rotary type fixture. Although not shown, the fixture 87 may be a fitting type fixture.

Meanwhile, although not described in the first embodiment, the necessities of a typical LED lighting device are naturally applied to the LED lighting device of the first embodiment.

### Second Embodiment

FIG. 4 illuminates an LED lighting device according to a second embodiment of the present invention. This LED lighting device can replace an existing lighting device such as a street lamp, floodlight, etc.

The LED lighting device according to the second embodiment includes a main frame 10 having the shape of a wide flat plate, an intermediate portion of which is open. A heat sink 30 is mounted in the intermediate opening of the main frame 10. A plurality of thermoelectric elements 40 and temperature sensors are installed at a lower portion of the heat sink 30. A fixing plate 65 is installed at a lower portion of the thermoelectric elements 40. A metal PCB 60 is installed on a lower surface of the fixing plate. A lamp module 77 having LED bulbs 70, each of which is provided with a lens, is installed on a lower surface of the metal PCB 60.

A switch mode power supply (SMPS) 15 is provided on one side of a lower surface of the main frame 10. A fixture 87 is provided on an upper surface of the main frame 10 such that the LED lighting device can be fixed to a post for a street lamp.

Further, a cooling fan 20 is provided on the other side of the upper surface of the main frame 10, and is located next to the heat sink 30. The cooling fan 20 sends air to the heat sink 30 next to the cooling fan 20, thereby cooling the heat sink 30.

An upper cover 85 covering the cooling fan 20 is provided at an upper portion of the main frame 10, and a lower cover 80 covering the entire lower surface of the main frame 10 including the lamp module 77, the SMPS 15, etc. is provided at a lower portion of the main frame 10.

Meanwhile, although not described in the second embodiment, necessities of a typical LED lighting device are naturally applied to the LED lighting device of the second embodiment.

### Third Embodiment

FIG. 5 illuminates an LED lighting device according to a third embodiment of the present invention. This LED lighting device can replace an existing lighting device such as a security lamp.

The LED lighting device according to the third embodiment includes a main frame 10 supporting the following components. A heat sink 30 is provided at an upper portion of the main frame 10. A cooling fan 20 is provided on an upper side of the heat sink 30.

Further, a thermoelectric element 40, a thermostat 51, a ceramic resistor 12, etc. are installed on a lower surface of the heat sink 30. The ceramic resistor 12 is generally used for the LED lighting device, and functions to prevent LEDs from being damaged by voltage drop.

A fixing plate 65 is provided at a lower portion of the main frame 10. A plurality of lamp modules 77, each of which includes a metal PCB 60 and an LED bulb 70, are mounted on a lower surface of the fixing plate 65.

Further, a lower cover 80 covering the lamp modules 77 and the fixing plate 65 is provided at the lower portion of the main frame 10.

In addition, a fixture 87 for fixing the LED lighting device to an external structure is provided at an upper end of the LED lighting device.

Meanwhile, although not described in the third embodiment, necessities of a typical LED lighting device are naturally applied to the LED lighting device of the third embodiment.

With the constructions of the aforementioned embodiments, the LED lighting device having high output power and excellent durability due to excellent cooling efficiency can be realized.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A light emitting diode (LED) lighting device comprising:
a main frame;
at least one metal printed circuit board (PCB) provided at the main frame and having at least one LED bulb installed on a lower surface thereof;
a heat sink provided on an upper side of the metal PCB, absorbing heat from the LED bulbs, and dissipating the heat into the air;
at least one thermoelectric element provided on a lower side of the heat sink and having a heat absorbing part at a lower portion thereof and a heat radiating part at an upper portion thereof;
a temperature sensor measuring temperature of the heat sink or the metal PCB; and
at least one cooling fan located on an upper portion or a side portion of the heat sink and inducing heat radiating from the heat sink to an outside to cool the heat sink.

2. The LED lighting device as set forth in claim 1, wherein the LED bulbs are installed on one metal PCB.

3. The LED lighting device as set forth in claim 2, further comprising a fixing plate provided on the upper side of the metal PCB.

4. The LED lighting device as set forth in claim 1, wherein the metal PCBs each include one LED bulb, and are fixed to a fixing plate on the upper side thereof.

5. The LED lighting device as set forth in claim 4, wherein the fixing plate is formed in a flat plate shape, or in a curved plate shape or a polyhedral plate shape such that the LED bulbs are installed in various directions and cast light at various angles.

6. The LED lighting device as set forth in claim 1, further comprising a heat insulator provided on the lower side of the heat sink such that the heat of the heat sink is prevented from being transferred to the metal PCB.

7. The LED lighting device as set forth in claim 1, further comprising a circuit board for controlling operation of the LED lighting device.

8. The LED lighting device as set forth in claim 2, further comprising a heat insulator provided on the lower side of the heat sink such that the heat of the heat sink is prevented from being transferred to the metal PCB.

9. The LED lighting device as set forth in claim 3, further comprising a heat insulator provided on the lower side of the heat sink such that the heat of the heat sink is prevented from being transferred to the metal PCB.

10. The LED lighting device as set forth in claim 4, further comprising a heat insulator provided on the lower side of the heat sink such that the heat of the heat sink is prevented from being transferred to the metal PCB.

11. The LED lighting device as set forth in claim 5, further comprising a heat insulator provided on the lower side of the heat sink such that the heat of the heat sink is prevented from being transferred to the metal PCB.

12. The LED lighting device as set forth in claim 2, further comprising a circuit board for controlling operation of the LED lighting device.

13. The LED lighting device as set forth in claim 3, further comprising a circuit board for controlling operation of the LED lighting device.

14. The LED lighting device as set forth in claim 4, further comprising a circuit board for controlling operation of the LED lighting device.

15. The LED lighting device as set forth in claim 5, further comprising a circuit board for controlling operation of the LED lighting device
